(19) United States
(12) Patent Application Publication
(10) Pub. No.: US 2023/0119144 A1
(43) Pub. Date: Apr. 20, 2023

(54) Bimodal stability controlled cutting apparatus with hands off operation

(71) Applicant: Brady Scott Haugo, Waterloo, IA (US)

(72) Inventor: Brady Scott Haugo, Waterloo, IA (US)

(21) Appl. No.: 17/966,851

(22) Filed: Oct. 16, 2022

Related U.S. Application Data
(60) Provisional application No. 63/256,552, filed on Oct. 16, 2021.

(51) Int. Cl. B27B 17/00; B27B 17/02; B27B 17/08; A01G 23/095

(52) U.S. Cl. CPC B27B 17/0083; A01G 23/095; B27B 17/02; B27B 17/08

(57) ABSTRACT

A cutting tool that contains the cutting forces within its assembly. The cutting tool includes an outside housing that attaches multiple jaws, attachment points for jaw clamping, anchor point to secure clamping forces, a bearing surface to allow saw bar movement, handles for user movement, and protection for internal components used in its operation. The jaws include interlocking gears to synchronize rotation, cross bracing, jaw clamping attachments points, and tie-offs for hoisting rope. The saw bar and chain electric motor attach to a rotation tube that is rotated by a worm gear situated at opposite end. Electrical power contained within the main housing is transferred to electrical chain motor using an electric rotary joint. The electric batteries and electric motor controller, electrical power switch and electrical fuse is contained within the main housing. Electro-pneumatic valves are situated in a separate housing and used for chain motor activation.

### BACKGROUND

### Field of Invention

This invention relates to the wood cutting field of devices. Wood cutting devices can use a variety of methods of material removal. The material removal allows the device to perform the anticipated action and create multiple pieces of wood from a single piece.

### Description of Problems Leading Up to Invention

Removing dead and dying branches requires the user to either use existing equipment that lets the user operate cutting device while standing on the ground, use lifting equipment that elevates the user up to the branch that is needing to be removed, or climb into the tree and use the branches of the tree support for the cutting operation. All of these methods allow for a high chance of user injury or expensive investment of equipment and personnel. Being able to reach high up into the trees and operate a cutting device while being able to remove yourself away from potentially dangerous falling branches and debris shows the need for this apparatus. Cutting branches that have fallen down after high winds provides another critical application. While a branch is lying on the ground internal stress may still be present with in the timber that is not evident. When a chainsaw user attempts to cut through downed trees the act of material removal upsets the internal stresses. As enough material is removed there is potential for the internal stresses to make the cut member act in spontaneous and erratic ways, this can put the chainsaw user in harm’s way with potential for serious injury to chainsaw user. Being able to operate a chainsaw in which the user is removed from the direct path of the spontaneous and erratic movement of the downed trees will keep the user safe from injury. This invention is intended to keep the user safer, allow the user access to heights previously un-accessible, and allow users with physical limitations the ability to operate a device that can cut wood.

### SUMMARY

High level description: Bimodal refers to the ability to use this device in different modes, aerial and ground mode. Aerial mode refers to using the device high up in a tree; ground mode refers to using the device while the user and device is contacting the ground. Current wood cutting devices are limited to applications that allow for users to operate cutting device while in direct contact with said cutting device. This creates a need for user to either be in direct vicinity of cutting area or connected through rigid members to create the stability needed to operate and apply forced needed to cut through the wood. Additionally, the user is required to apply the stability forces needed for the cutting apparatus to operate with limited movement and vibration. In effect this limits the user’s ability to cut limbs and branches off of trees within a vertical limit dictated by the strength and rigidity of apparatus connected to user. This invention allows the user to cut down branches high up in trees while keeping user away from falling debris. This also allows users the ability to cut branches on the ground while keeping them away from hazardous kick back of the branch.

### Problems Solved Using Invention

Using this invention will help reduce the likely hood of user injury compared to other methods of cutting branches. This invention will also allow users with limited mobility or strength in one arm the ability to use a chainsaw in a safe manner. This invention will help users with limited resources be able to cut down branches without the difficulty of the current equipment designed for this application, like bucket lifts, tree climbing harness, etc.

What makes this invention special/different? This invention is different from a standard chain saw in a couple key ways. This invention has jaws that when actuated will grab onto the material being cut. Grabbing onto the material being cut eliminates the requirement of the user to stabilize the cutting blade. This invention allows the user to rotate the blade completely around with continuous rotation, allowing the user to start cutting the material at the most opportune location, without twisting any of the motor power wires. This device also allows for blade lubrication through the center of rotation. This invention has dual inputs for rotating the cutting blade. The first input is a hand crank wheel attached to the side and back of the device. The user can rotate this crank to turn the blade with an increase of mechanical leverage allowing the user to slowly and carefully feed the cutting blade into the material. The second input method for rotating the blade is a device attached to the hand crank that is inboard of the hand crank. This device, called a capstan, allows a rope to wrap around in a continuous fashion. The capstan can create rotation torque from linear movement of the rope. The amount of rotational torque created is proportional to the tension of the following rope. The user can adjust the amount of rotational torque applied to the cutting blade by modulating the amount of tension of the following rope while maintaining a pulling force with the leading rope. This invention is powered using an electric motor with the batteries onboard to the device. The actuation of the electric motor is accomplished using pressured air for its aerial mode, and a standard electrical switch for its ground mode. Using pressured air allows the user to actuate the motor and clamping jaws while being electrically isolated from the device. Having only electrically insulating pneumatic hoses reduces the chance of electrical current being transmitted to the device if the user is to accidentally get to close to a high voltage power wire. The actuation of an electric motor using pressurized air requires an air over mechanical switch. The clamping jaws are also actuated using pressurized air for its aerial mode, a linear ratchet mechanism is used for its ground mode. When the user actives the air pressure going to the clamping jaw cylinder, the jaws close and maintain its clamping pressure onto the cutting member. This creates the stability that keeps the device in place. The linear ratchet used during its ground mode, acts similar to the air cylinder but activation is accomplished through a ratchet handle that rotates back and forth.

The construction of this device is a delicate balance of strength, rigidity, light weight and cost. Numerous iterations have been tried with many different materials selected. Due to the constraints high strength is required in certain areas. For instance, weak materials would bend when the clamping cylinder is actuated and would not allow the cutting blade to rotate. If stronger but heavier materials are used the device would be too heavy to allow the user to lift it into the trees. Special attention has been applied to the design and construction of this device to create the rigidity needed while not adding additional material that would weigh it down. Description of what this invention does.

This invention is a specialized type of chainsaw that allows the user the ability to cut branches high up in the trees without the need for lifting equipment or climbing harnesses. This invention also allows the user to cut down limbs that are lying on the ground; these can create specific danger as they contain trapped internal energy that is released during cutting.

When used up in the trees this invention requires the user to place a rope over the limb that needs to be cut. Placing a rope over the limb can be accomplished using different methods. A weight attached to a rope can be thrown over the limb. A long pole that grabs the rope can be used to place the rope over the branch and then pull the rope down, or use a weight to have gravity pull the rope down. Once the rope has been placed over the branch the user attaches the rope to the invention using a knot. The user then needs to unwind the capstan ropes as well as the pneumatic pressure hoses. The user needs to place the rope and hoses in a manner that allows the user to elevate the invention with minimum disturbance to the inventions upward path and rotational balance. The user then needs to pull the rope that lifts the invention up to the branch. Once the invention is at the branch the user then pushes the jaw actuation button on the control box. This control box has a pressure line attached to a pneumatic air compressor. This air compressor should be battery operated to eliminate any additional wires and allow the user greater access to remote locations. The control box has 2 manual air valves, these air valves are 5 port 3 way type control valves. When the user presses the button on the manual air valve attached to the clamping jaws, the clamping jaws actuate and grab onto the branch. Once the invention is clamped onto the branch the user then determines which direction to rotate the blade. It is very critical the user chooses the correct angle for the blade to start cutting. The user needs to cut through the branch in an angle such that the weight of the branch does not pinch the blade. The user will then insert or screw a post into the ground and tie the remaining piece of the lifting rope onto the post, so that any accidental release of the clamping jaws does not allow the invention to fall to the ground. Once the user has chosen the correct angle to cut the branch the user will start to pull on one side or the other of the capstan rope, depending on which rope the user pulls will determine which direction the blade rotates. Once the user gets the blade close to the branch the user will actuate the other manual 5 port 3 way air valve. This will send pressure up to the invention and actuate the air over mechanical electrical switch. This completes the circuit and allows electricity to flow from the batteries and start rotating the chain motor. With the chain now turning, the user feeds the bar into the branch and begins the cutting operation. As the user cuts through the branch, the user will take note to remove anything of value from below the area where the branch will fall.

The usage of this invention on the ground follows similar application with elimination of the need to lift the unit up into the tree. The unit can be retrofitted to make ground based usage easier. This entails the change of handles and switches. Changing out the handle and switches will allow the user the ability to control the jaw clamping and motor activation one handed without putting the device down. These retrofit parts are not required to use the device in its terrestrial state. The user can also choose to rotate the blade using the hand crank handle or the capstan ropes depending on the danger or how far away the user wants to be from the cutting bar. While using this invention in its terrestrial mode, similar techniques of cutting are used. The user must choose which side of the log the user wants to start on, the user then rotates the cutting bar around to start the cut on the preferred side. The user then slowly feeds the cutting bar into the log in a slow and consistent manner. Once the cutting bar has traveled through the log the user must then pay attention and remove anything of value from where the debris might fall.

### BRIEF DESCRIPTION OF INVENTION

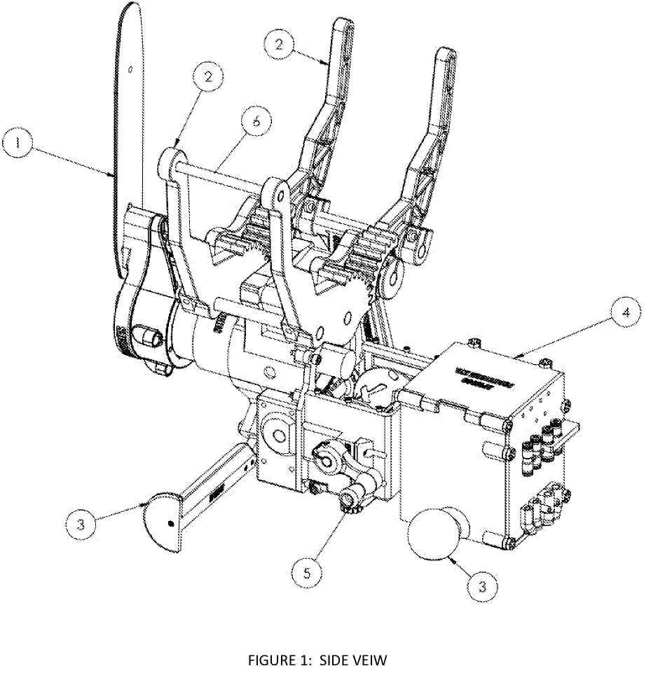

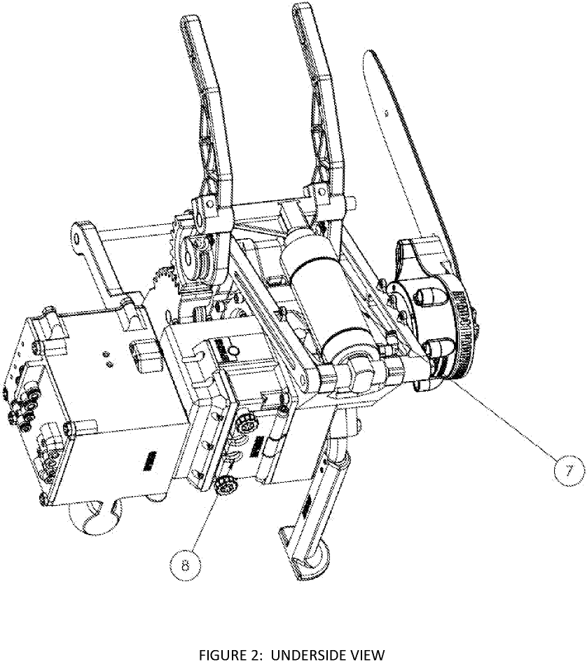

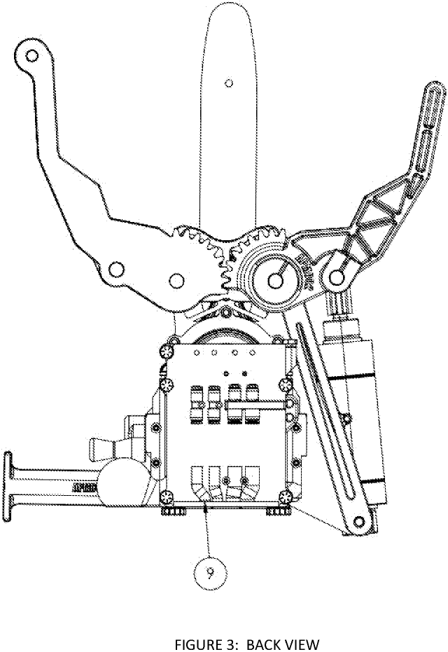

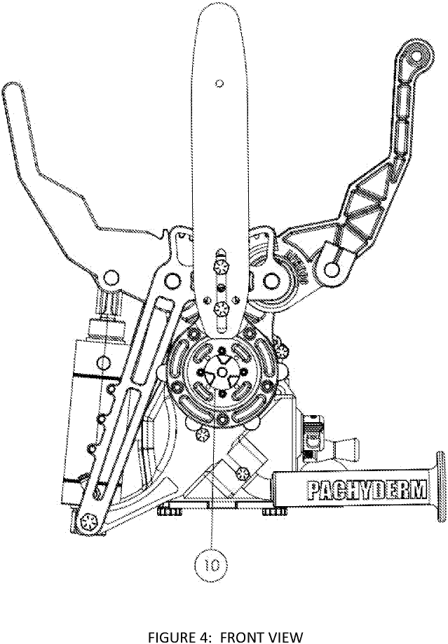

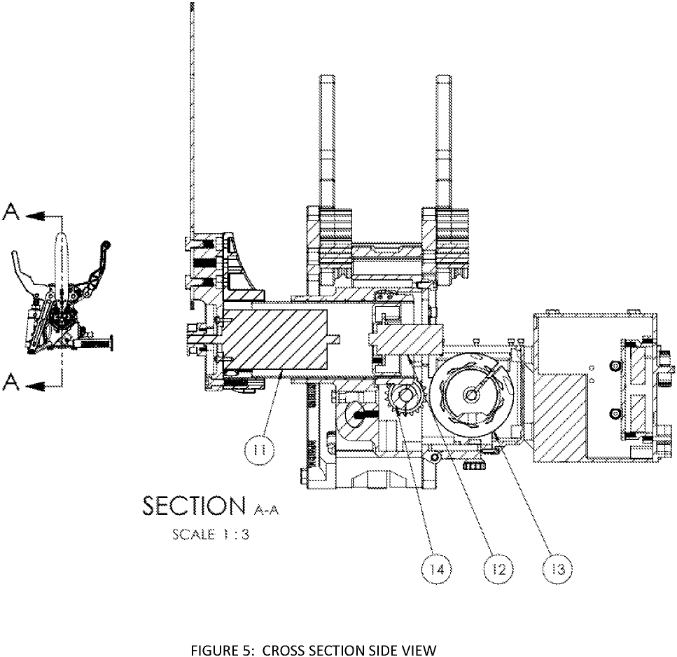

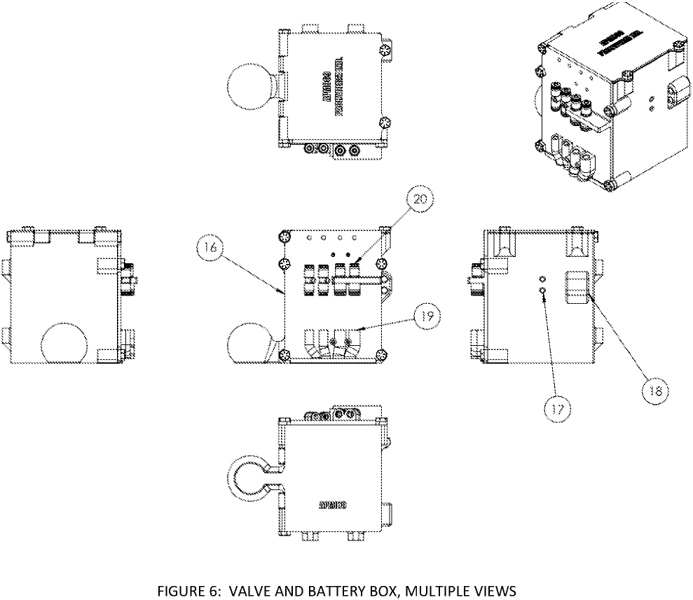

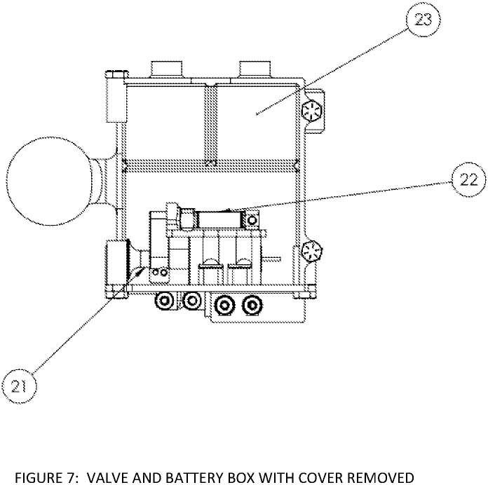

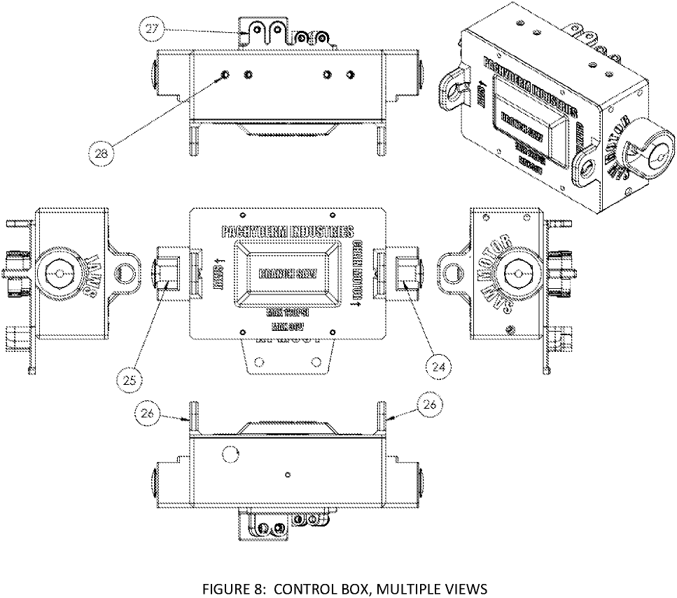

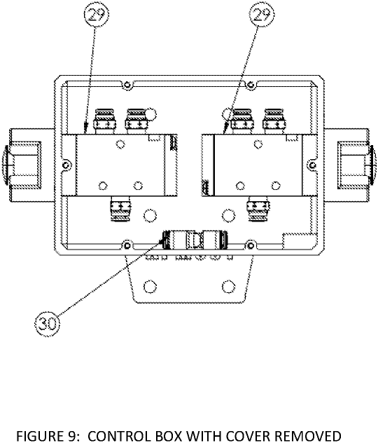

This section briefly describes the figures included in the drawing section. Page 1 FIG. 1 shows the side view of the invention; items 1 through 6 indicate individual components of the invention. Page 2 FIG. 2 shows the underside of the invention, balloons 7 and 8 are individual components of the invention. Page 3 FIG. 3 shows the back side of the invention, balloon number 9 is a component of the invention. Page 4 FIG. 4 shows the front side of the invention. Balloon number 10 shows a component of the invention. Page 5 FIG. 5 shows a cross section side view of the invention; balloons 11 through 13 are components of the invention and are also shown as a cross section side view. Page 6 FIG. 6 shows a separate component for this invention, namely the valve and battery box, balloons 16 through 20 show individual components within the separate component of this invention. Page 7 FIG. 7 shows the same component as page 6, namely the valve and battery box, with additional detail as a component is excluded from the view, namely the cover, to allow the reader to see into this component with more clarity, balloons 21 through 23 are individual components with this separate component of this invention. Page 8 FIG. 8 shows a separate component of this invention, namely the control box that is not attached to the main invention. Balloons 24 through 28 are separate components within this component that is part of the main invention. Page 9, FIG. 9 shows the same component as page 8 FIG. 8, namely the control box, with a component excluded from the view, namely the cover, to allow the reader more clarity to view the internal components.

### DETAILED DESCRIPTION OF INVENTION

This invention is as described. This section describes the drawings in further detail.

Page 1 balloon number one shows the chain bar, this is a metal blade with a channel running along its perimeter allowing the chain to rotate. Page 1, balloon number 2 is the clamping jaw, this item is made from plastic that should allow a little flexibility but still rigid enough to allow force to be transmitted to structure that is to be cut. This material needs to be able to withstand hot and cold temperatures as well as heat generated from solar radiation. PETG is a type of plastic that will work well for this application. The jaw needs to be designed to reduce weight while still allowing it to retain rigidity. The jaw needs to have a gear structure on the bottom half of it to allow rotation in sync with the jaws on the other side. Page 1, balloon item 3 is a handle, this handle needs to have rigidity to allow the user to pick up and grab device without undue flexing. This handle also needs to be constructed to reduce weight and increase rigidity, plastics such as PETG work well for this component. The handle can be constructed using additive manufacturing or through plastic injection molding. Orientation of component during manufacturing is critical to keep the strength sufficient. Page 1 balloon item 4 is a box made from plastic that is rigid but can give slightly when experiencing stress. PETG is a good plastic to use in this application. This component can be made from additive manufacturing as well as plastic injection molding. This item houses the batteries required to power the electric motor. This item also houses the air over electric switches that activate the motor as well as an additional switch that only allows the motor to engage when the jaws are activated. Page 1 balloon 5, this is a crank handle that is connected to an aluminum shaft that passes into the internals of the unit and spins the capstan pulley. This pulley is connected with 2 separate chains to a worm gear, this worm gear then engages with a mating worm gear attached to the main rotation tube. By turning the crank at item number 5 this will rotate the main rotation tube which the blade is connected to. This is how the unit engages the cutting chain into the material being cut. The handle can be made from a light weight material like plastic or aluminum. Page 1 balloon 6 is an aluminum shaft that connects two of the clamping jaws. This aluminum shaft is used to tie on a rope. This rope is used to hoist the entire mechanism up into the tree. Page 2 balloon 7 shows a pneumatic cylinder, this can also be an electric actuator, or a manual linear actuator. This device when activated will close the clamping jaws and hold on tight to the branch or log that is being cut. Page 3, balloon 9 is the back and it is pointing to the back end of the valve and battery box, there are quick disconnect fittings that connect to pneumatic lines that run from this device to the user input device, this allows the user to actuate the clamping jaws or the electric motor that spins the cutting chain. Page 4 balloon 10 is pointing to the cutting chain sprocket. This is a hardened metal component that is attached to the end of the motor and transfers power from the motor to the cutting chain. Page 5 balloon 11 is an electrical motor; this can be either AC or DC. This motor needs to be of sufficient power and speed to spin the cutting chain at an appropriate speed. This motor connects directly to the sprocket. The wires for the motor pass into the item designated by balloon 12, this is an electrical slip ring that allows the main rotating tube to spin completely around without tangling up the electrical wires, and the electrical slip ring needs to be of sufficient ability to carry the voltage and current that the electrical motor requires. Page 5, item 13 is a capstan; this is made out of light weight plastic. The capstan allows the user to wrap a rope around the capstan and rotate the cutting blade from a remote distance where by the only connection to the user is the rope that is wrapped around the capstan. Page 5, balloon 14 is a combination chain sprocket and worm gear, this component is made from plastic or another lightweight material, this component takes rotational movement of the capstan and is a gear reduction to the worm gear drive. Page 5, balloon 15 is a cover that shields the internals from moisture and debris, this component needs to be made from lightweight material like plastic or aluminum. Page 6, balloon 16 is a valve and battery box made from lightweight plastic, balloon 17 and 18 shows the exits that 2 pneumatic hoses pass through, these hoses will get plumbed to the pneumatic cylinder that moves the clamping jaws. Page 6 item 19 is a strain relief that helps keeps the pneumatic hoses from pulling out of the push-to-connect fittings shown as balloon 20. Page 7 balloon 21 is an electrical switch that is actuated by a small pneumatic cylinder balloon 22; this allows the user to actuate the motor while not being connected to the device by any electrical wires. Being isolated from the this cutting apparatus by plastic pneumatic lines means the user does not have as much risk working near electrical power transmission lines. Page 7 balloon 23 is the area where the battery pack is placed. Page 8 balloons 24 and 25 are manual air valves, these valves will pressurize either of the 2 pneumatic hoses that are connected to it, and both of these valves are also connected to air hoses connected to an air compressor. When the buttons on these valves are pushed or pulled it changes which line is pressurized. These valves control the actuation of the clamping jaws and also the motor that turns the cutting chain. When the user wants to actuate the jaws they pull out the button at balloon 25, when the user wants to turn the motor on they must first actuate the jaws, and then actuate the motor using the button shown by balloon 24. The motor will only operate if the jaws are first actuated, this minimizes the risk of accidentally turning the motor on when the user has not intended for it to turn on. Page 8 balloon 26 shows a bracket that is used to attach a lanyard such that the user can hang this from their neck if they desire. Balloon 27 shows a strain relief bracket that helps keep the pneumatic hoses from being pulled out of the push-to-connect fittings. Balloon 28 is pointing to area the pneumatic hoses enter to the control box. Page 9 balloon 29 shows the manual pneumatic valves; balloon 30 is a push-to-connect y splitter that splits the incoming air into two different lines.

This concludes the description of the Bimodal stability controlled cutting apparatus with hands off operation.

What is claimed is:

1. Bimodal stability controlled cutting apparatus with hands off operation comprising:
A housing having a first end, second end, top end and bottom end. A rotatably coupled motor tube between top and bottom end with end of motor tube consisting of first end and second end. The motor tube having first end between first and second end of housing and second end in line with second end of housing. A rotatably coupled jaw attachment on top end of housing with rotation axis parallel to rotatably coupled motor tube.

2. A Bimodal stability controlled cutting apparatus with hands off operation of claim 1 with at least one clamping jaw rotatably attached to jaw attachment point on housing.

3. A Bimodal stability controlled cutting apparatus with hands off operation of claim 2 with jaws locked into rotational synchronization.

4. A Bimodal stability controlled cutting apparatus with hands off operation of claim 1 where in the motor tube and bar rotation is manually controlled using plurality of input methods from user.

5. A Bimodal stability controlled cutting apparatus with hands off operation of claim 4 wherein the rotation of motor tube and cutting bar is actuated by rotation of worm gear mechanism situated at second end of housing.

6. A Bimodal stability controlled cutting apparatus with hands off operation of claim 5 is where in rotation of worm gear mechanism is accomplished by rotating a handle.

7. A Bimodal stability controlled cutting apparatus with hands off operation of claim 5 where rotation of worm gear mechanism is accomplished by rotating a capstan pulley and rope assembly.

8. A Bimodal stability controlled cutting apparatus with hands off operation of claim 1 wherein the motor that drives the cutting chain is activated and deactivated using an air over mechanical electrical switch.

9. A Bimodal stability controlled cutting apparatus with hands off operation of claim 8 wherein the motor that drives the cutting chain can be activated and deactivated remotely by sending pressurized air through the remote-control valve to the air over mechanical electrical switches.

10. A Bimodal stability controlled cutting apparatus with hands off operation of claim 3 wherein the jaws are open and closed using an air cylinder with one end attached to jaws and opposite end attached to housing.

11. A Bimodal stability controlled cutting apparatus with hands off operation of claim 10 wherein the air cylinder is activated and deactivated by sending air pressure through the remote-control valve to air cylinder.
